(19) United States
(12) Patent Application Publication
(10) Pub. No.: US 2008/0075341 A1
(43) Pub. Date: Mar. 27, 2008

(54) IMAGE STORAGE APPARATUS

(76) Inventor: Akira GOTO, Otawara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/857,726

(22) Filed: Sep. 19, 2007

(30) Foreign Application Priority Data
Sep. 26, 2006 (JP) 2006-261117

(51) Int. Cl. G06K 9/00

(52) U.S. Cl. 382/128

(57) ABSTRACT

A medical image storage apparatus includes a first image storage unit that stores medical image information including a plurality of medical images having predetermined array information, an image specifying unit that specifies a key image from the plurality of medical images on the basis of key image information showing a key image in the medical image information, and that specifies a predetermined number of medical images on the basis of the key image information and the array information, and an image storage and management unit that deletes a medical image excluding the specified medical images of the medical image information from the first image storage unit or compresses the medical image at a higher compression rate than the key image.

### CROSS-REFERENCE TO RELATED APPLICATIONS

This application is based upon and claims the benefit of priority from prior Japanese Patent Application No. 2006-261117, filed Sep. 26, 2006, the entire contents of which are incorporated herein by reference.

### BACKGROUND OF THE INVENTION

1. Field of the Invention

The present invention relates to an image storage apparatus for storing a number of medical images.

2. Description of the Related Art

Conventionally, various medical image storage apparatuses that are connected via a network, etc. to a medical image diagnostic apparatus, such as an X-ray CT apparatus or an MRI apparatus, and that are able to store and manage medical images acquired by the medical image diagnostic apparatus are suggested.

In recent years, the functions of the medical image diagnostic apparatuses have been highly advanced, and the number of medical images acquired during single inspection has been significantly increased. For this reason, the resources of the medical image diagnostic apparatuses (the capacity of a memory device for storing medical images or various kinds of information relating to the medical images) are consumed, and the load of CPUs for executing various kinds of control in the medical image storage apparatuses also increases easily.

Thus, in order to effectively utilize the resources of the medical image storage apparatuses, for example, a method as described in JP-A-2006-113779 is considered. In this JP-A-2006-113779, medical images having a higher reference frequency among those acquired in large quantities in a medical image diagnostic apparatus are stored in a hard disc in an image storage apparatus (image server), and medical images having a smaller reference frequency are stored in a removable disc, such as an optical disc. As a result, the capacity of the hard disc can be saved, and medical images the reference possibility of which is high can be read from the hard disc. Thus, it is possible to efficiently refer to the medical images.

In JP-A-2006-113779, all the medical images acquired in the medical image diagnostic apparatus are not stored in the hard disc of the image server, but they are stored on the basis of the aforementioned predetermined reference. Here, in a diagnosis report generating system that searches a medical image stored in, for example, a medical image storage apparatus to display it on a predetermined display device (image viewer), and interprets the displayed medical image to generate a diagnosis report, a medical image obtained in the present inspection and a medical image obtained in the past inspection are compared with each other. However, such medical images are not limited to those left in the hard disc according to the aforementioned reference.

### BRIEF SUMMARY OF THE INVENTION

The object of the invention is to provide a medical image storage apparatus that can store only required medical images to effectively utilize resources.

A medical image storage apparatus according to a first aspect of the invention includes: a first image storage unit that stores medical image information including a plurality of medical images having predetermined array information; an image specifying unit that specifies a key image from the plurality of medical images on the basis of key image information showing a key image in the medical image information, and that specifies a predetermined number of medical images on the basis of the key image information and the array information; and an image storage and management unit that deletes a medical image excluding the specified medical images of the medical image information from the first image storage unit or compresses the medical image at a higher compression rate than the key image.

Additional objects and advantages of the invention will be set forth in the description which follows, and in part will be obvious from the description, or may be learned by practice of the invention. The advantage of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above, and the detailed description of the embodiments given below, serve to explain the principles of the invention.

FIG. 1 is a view showing the construction of a diagnosis report generating system including a medical image storage apparatus according to a first embodiment of the invention;

FIG. 2 is a flowchart showing medical image deleting processing to be performed in a control unit of an image server; and

FIG. 3 is a view showing the concept of the processing of determining a deletion target image if key image information is stored.

### DETAILED DESCRIPTION OF THE INVENTION

Hereinafter, embodiments of the invention will be described with reference to the drawings.

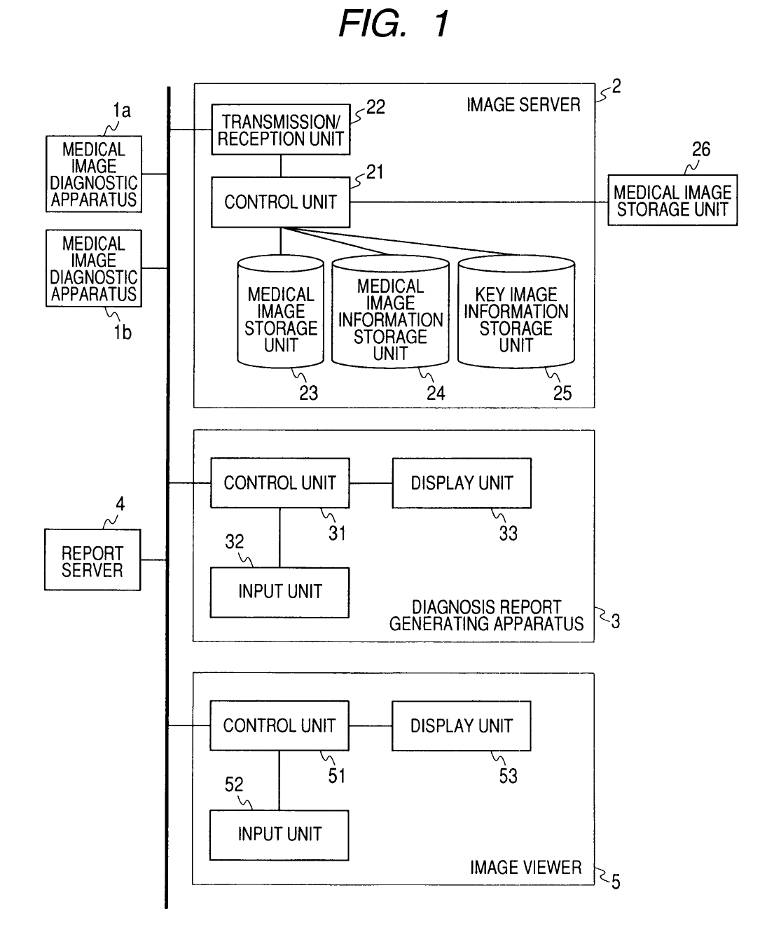

FIG. 1 is a view showing the construction of a diagnosis report generating system including a medical image storage apparatus according to a first embodiment of the invention. The diagnosis report generating system shown in FIG. 1 includes medical image diagnostic apparatus 1a or 1b, an image server 2, a diagnosis report generating apparatus 3, a report server 4, and an image viewer 5. Here, individual blocks are data-communicably connected to one another in a manner shown in FIG. 1.

The medical image diagnostic apparatus 1a or 1b take an image of the inside of the body of a subject to generate medical image data. Here, as the medical image diagnostic apparatus 1a or 1b, there are, for example, an X-ray CT apparatus, an MRI apparatus, an ultrasonic diagnostic apparatus, an X-ray diagnostic apparatus, and the like. In addition, although two medical image diagnostic apparatuses are shown in FIG. 1, one medical image diagnostic apparatus may be adopted or three medical image diagnostic apparatuses may be adopted.

The image server 2 serving as a medical image storage apparatus according to the present embodiment stores and manages medical image information including a plurality of pieces of medical image data acquired by the medical image diagnostic apparatus 1a or 1b. Here, the image server 2 includes a control unit 21, a transmission/reception unit 22, a medical image storage unit 23, a medical image information storage unit 24, and a key image information storage unit 25. Moreover, a medical image storage unit 26 is connected to the image server 2.

The control unit 21 controls various kinds of processing in the image server 2. Further, the control unit 21 has a function as an image specifying unit that specifies a key image from the medical image information stored in the medical image storage unit 23 according to the key image information (the details thereof will be described below) to be stored in the key image information storage unit 25. Moreover, the control unit 21 also has a function as an image storage and management unit for managing medical images to be stored in the medical image storage unit 23.

The transmission/reception unit 22 performs transmission and reception of various kinds of data among the image server 2, the medical image diagnostic apparatus 1a or 1b, and the report server 4.

The medical image storage unit 23 serving as a first image storage unit stores medical image information including a plurality of pieces of medical image data acquired by the medical image diagnostic apparatus 1a or 1b. This medical image storage unit 23 is not particularly limited so long as it is a large capacity of memory device that can store a large number of pieces of medical image information. For example, optical discs or hard discs, such as DVDs, can be used.

The medical image information storage unit 24 stores various kinds of information related to medical image information, such as the kind of a medical image diagnostic apparatus that has acquired medical image information, the time of acquisition of the medical image information stored in the medical image storage unit 23, and imaging information including the inspection contents, inspection parts, and imaging positions when the medical image information is acquired, in association with the medical image information of the medical image storage unit 23.

The key image information storage unit 25 stores the positional information (stored address information of a key image) of a key image including an image that is selected in order for a doctor to make a diagnosis and an image that is used in order for the image-interpreting doctor to generate a diagnosis report, among the medical image information stored in the medical image storage unit 23.

The medical image storage unit 26 serving as a second image storing unit is provided as an auxiliary image storage apparatus of the image server 2. This medical image storage unit 26 stores the medical image data (the details thereof will be described below) that is not stored in the medical image storage unit 23. This medical image storage unit 26 may use the same medium as the medical image storage unit 23, or may use a memory device having a smaller capacity than the medical image storage unit 23 like a recording medium utilizing a magnetic tape.

The diagnosis report generating apparatus 3 is a terminal apparatus that receives operational input by an image-interpreting doctor, etc. to generate an electronic diagnosis report. This diagnosis report generating apparatus 3 is, for example, a personal computer (PC) in which application software for generating a predetermined diagnosis report is installed, and includes a control unit 31, an input unit 32, and a display unit 33. The control unit 31 controls various kinds of processing in the diagnosis report generating apparatus 3. The input unit 32 is an input for operating the diagnosis report generating apparatus 3. This input unit 32 may include, for example, a key board for performing input of characters on a predetermined diagnosis report generation screen, or a pointing device, such as a mouse, for performing various kinds of instruction operation. The display unit 33 displays various kinds of information, such as medical images stored in the medical image storage unit 23 of the image server 2 or a diagnosis report generation screen necessary for generating a diagnosis report.

The report server 4 stores a diagnosis report generated in the diagnosis report generating apparatus 3 in association with diagnosis report information including a generation data of the diagnosis report, an inspection ID, an inspection part, the information of a medical image (key image) used during the generation of the diagnosis report. Here, in the present embodiment, as well as the key image information is stored in the report server 4, it is also stored in the key image information storage unit 25.

The image viewer 5 is a terminal apparatus that receives operational input by an image-interpreting doctor, etc. to generate an electronic diagnosis report. This image viewer 5 is, for example, a personal computer (PC) in which application software for displaying a predetermined diagnosis image is installed, and includes a control unit 51, an input unit 52, and a display unit 53. The control unit 51 controls various kinds of processing in the image viewer 5. The input unit 52 is an input for operating the image viewer 5. This input unit 52 may include, for example, a pointing device, such as a mouse, for performing operation, such as selecting a key image from the medical images displayed on the display unit 53 of the image viewer 5. The display unit 53 displays various images, such as medical images stored in the medical image storage unit 23 of the image server 2 or a diagnosis report stored in the report server 4.

Hereinafter, the operation of the diagnosis report generating system shown in FIG. 1 will be described. First, inspection of a subject is performed in the medical image diagnostic apparatus 1a or 1b. In this inspection, first, scout imaging for determining a position where a tomogram is obtained is performed. As for this scout imaging, for example, in the case of an X-ray CT apparatus, X-ray radiation is performed while a bed ceiling plate on which the subject is placed is moved in the direction of a body axis of the subject, without rotating an X-ray tube. On the basis of the projection data obtained at this time, a scout image is generated and is displayed on a display of the X-ray CT apparatus. The slicing positions of tomograms during main imaging are set on the displayed scout image.

After the position of the tomogram is set, main imaging is performed in the set slicing position whereby a plurality of tomograms (medical image data) having predetermined array information (namely, information of slicing position) are obtained. Thereafter, if necessary, a three-dimensional image is reconstructed from the tomograms, and an inspected part of a subject is displayed as a three-dimensional image on a display. Further, tomograms having a larger slicing thickness than a slicing thickness during the main imaging, which is required during image interpretation, are generated from the tomograms obtained in the main imaging. In addition, the thick sliced tomograms are not necessarily generated from the thin sliced tomograms. For example, tomograms having an arbitrary thickness can also be generated from the volume data obtained during three-dimensional reconstruction.

After the inspection as described above, the medical image data generated in the medical image diagnostic apparatus 1a or 1b is delivered to the image server 2, together with the medical image information. Here, the medical image data, specifically, the scout image obtained by the scout imaging, the sliced tomograms serving as a first medical image group obtained by the main imaging, the sliced tomograms (interpretation images) for image interpretation serving as a second medical image groups generated from the above sliced tomograms, is delivered to the image server 2 from the medical image diagnostic apparatus 1a or 1b. In addition, the term “sliced” means a minimum unit group on the Digital Imaging and Communications in Medicine (DICOM) standard, and a medical image group classified according to image generation time, slicing thickness, and existence/non-existence of a contrast medium, for each part of a body imaged.

Further, if any post-processing has been performed on the tomograms obtained by the main imaging, the post-processed images are delivered to the image server 2. The image data, which is delivered in one inspection, of these images is handled as one medical image information. Accordingly, all or at least any one of the scout image, the first medical image group, the second medical image group, and the post-processed images may be included in the medical image information.

The medical image data delivered to the image server 2 is received in the transmission/reception unit 22, and delivered to the control unit 21. The control unit 21 stores the medical image data received via the transmission/reception unit 22 in the medical image storage unit 23, and stores the medical image information including this medical image data in the medical image information storage unit 24.

Thereafter, when a diagnosis report is generated, the diagnosis report generating apparatus 3 is started by an image-interpreting doctor, etc. Then, the medical image information stored in the medical image storage unit 23 of the image server 2 is called upon reception of input from the input unit 32, and the medical image data included in the information is displayed on the display unit 33. The image-interpreting doctor, etc. views the medical image data to make a diagnosis, and generates a diagnosis report on the basis of the result of the viewing. The generated diagnosis report is stored in the report server 4, together with the diagnosis report information. Further, as described above, in the present embodiment, the information of a key image used to generate a diagnosis report is also delivered to the key image information storage unit 25 of the image server 2.

Further, the diagnosis report stored in the report server 4 or the medical images stored in the image server 2 can also be viewed on the display unit 53 of the image viewer 5.

In the diagnosis report generating system having such a construction, a plurality of pieces medical image data generated by the medical image diagnostic apparatus 1a or 1b are stored in the medical image storage unit 23 of the image server 2. In the present embodiment, the resources of the image server 2 can be effectively utilized by performing medical image deleting processing to be explained below, to thereby arrange the medical image data to be stored in the medical image storage unit 23.

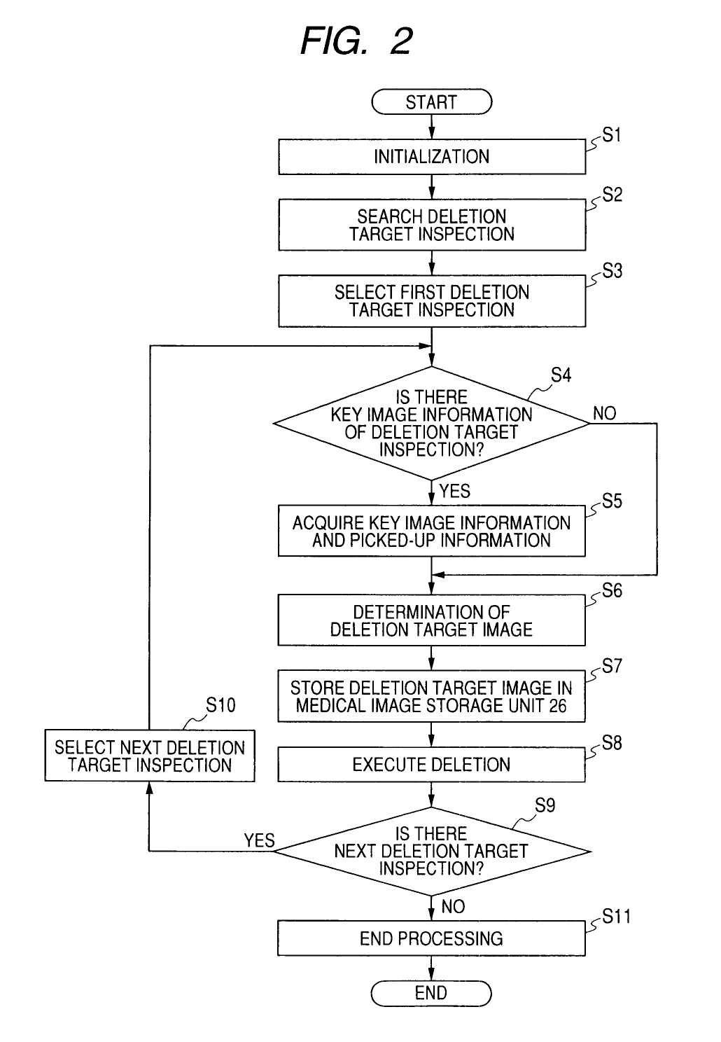

FIG. 2 is a flowchart showing medical image deleting processing to be performed in the control unit 21 of the image server 2. The processing of FIG. 2 is the processing performed by utilizing a spare time zone (night time, etc.) of the image server 2 in every predetermined period of time (for example, everyday, one time during a week, etc.).

First, the control unit 21 initializes various kinds of information, such as the information on a deletion target inspection to be searched in Step S2 (Step S1). Next, the control unit 21 searches the inspection ID of an inspection as a target to be deleted from the medical image data stored in the medical image storage unit 23 from the medical image information stored in the medical image information storage unit 24 (Step S2). The deletion target may be, for example, all inspections, or only the inspections after predetermined time or more has lapsed from an acquisition date (that is, inspection date) of certain medical image information. This period is defined as a period (for example, 10 years) that exceeds at least a period according to a law prescribed in every country. Further, even if this period has been exceeded, it is preferable that the medical images of a subject who is less than twenty years old are stored until the subject's age exceeds twenty years. Further, it is preferable that the medical images of special cases, such as Human Immunodeficiency Virus (HIV), may be stored permanently irrespective of a period of time.

Further, a doctor may arbitrarily set a deletion target inspection or a non-deletion target inspection. This setting of a deletion target inspection or a non-deletion target inspection may be performed, for example, during generation of a diagnosis report by the diagnosis report generating apparatus 3 or during viewing of a medical image or a diagnosis report by the image viewer 5. If the intent to delete a target or the intent not to delete a target inspection is set, the intent is added to a corresponding inspection of the medical image information of the medical image information storage unit 24.

After completion of the search of a deletion target inspection, the control unit 21 selects a first target inspection of deletion target inspections (Step S3). Then, the control unit 21 determines whether or not key image information related to the deletion target inspection is stored in the key image information storage unit 25 (Step S4). If the key image information is stored as a result of the determination of Step S4, the control unit 21 acquires key image information relating to the deletion target inspection stored in the key image information storage unit 25 and imaging information relating to the deletion target inspection stored in the medical image information storage unit 24 (Step S5). Thereafter, the process proceeds to Step S6. On the other hand, if any key image information is not stored as a result of the determination of Step S4, the process proceeds to Step S6 without performing the processing of Step S5.

Next, the control unit 21 determines the medical image data to be deleted from the medical image data acquired in the deletion target inspection (Step S6). This processing of determining a deletion target image will be described later. After the determination of a deletion target image, the control unit 21 stores the deletion target image in the medical image storage unit 26 (Step S7), and then deletes it from the medical image storage unit 23 (Step S8). Thereafter, the control unit 21 determines whether or not there is any next deletion target inspection (Step S9). If there is any next deletion target inspection as a result of the determination of Step S9, the control unit selects the next deletion target inspection (Step S10), and returns to Step S4. On the other hand, if there is no next deletion target inspection as a result of the determination of Step S9, the control unit performs end processing (Step S11), and ends the processing.

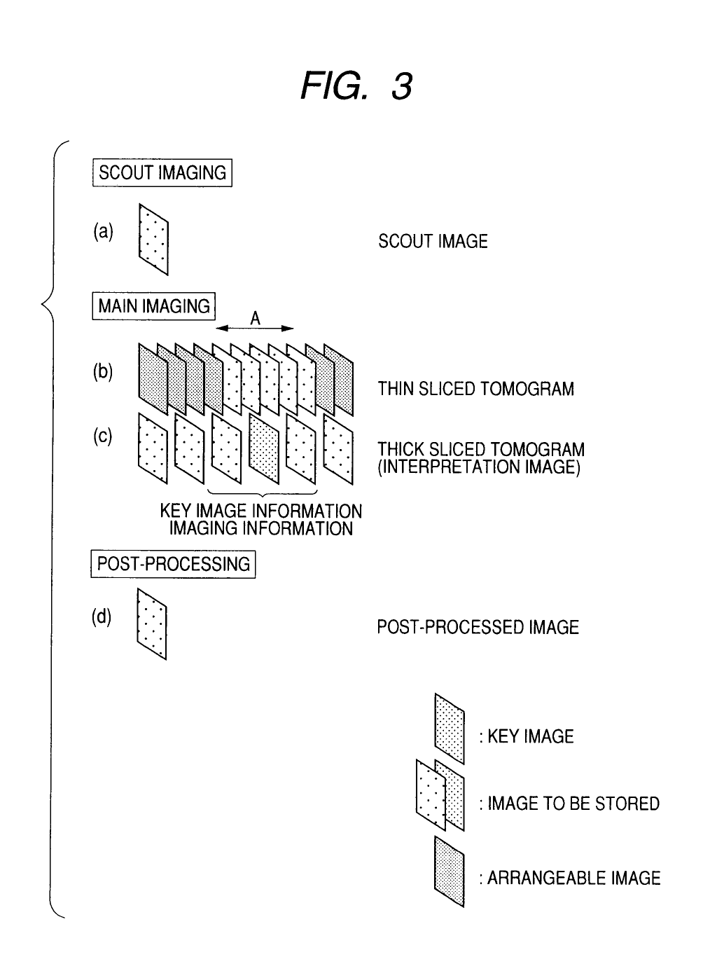

Next, the processing of determining a deletion target image in Step S6 will be described with reference to FIG. 3. FIG. 3 is a view showing the concept of the processing of determining a deletion target image if key image information is stored.

As described above, (a) a scout image, (b) thin sliced tomograms acquired by main imaging, (c) thick sliced tomograms (interpretation images) generated from the thin sliced tomograms, and (d) the post-processed images are included in the medical image information stored in the medical image storage unit 23. In the present embodiment, among these four kinds of medical image data, first, the scout image and the post-processed image are determined so as to be stored in the medical image storage unit 23.

Next, the key image is an image to be used for generation of a diagnosis report. This key image is determined so as to be stored in the medical image storage unit 23 because there is a possibility that the key image is referred to if the same inspection or similar inspection is performed on the same subject in future. Since there is also a possibility that the other thick sliced tomograms are referred to, these are determined so as to be stored in the medical image storage unit 23.

Finally, the thin sliced tomograms are used in order to generate an interpretation image, or generate and display a three-dimensional image or orthogonal three-sectional image of an inspection part in the medical image diagnostic apparatus 1a or 1b. That is, although the thin sliced tomograms are needed at the time of inspection, they are hardly needed for generation of a diagnosis report after the inspection, and they may thus be disposed. However, for example, if the display unit 33 has a function to generate and display a three-dimensional image, a case where a doctor, etc. desires to view a three-dimensional image of an inspection part during generation of a diagnosis report is also considered.

Thus, in the present embodiment, the thin sliced tomograms are determined so as to be stored in the medical image storage unit 23 as much as needed. That is, since it is considered that only a key image and its surrounding images are needed during generation of a diagnosis report or during comparison in the subsequent inspection, only tomograms corresponding to surrounding images of a key image within shown in FIG. 3A are determined so as to be stored in the medical image storage unit 23 on the basis of slicing position information.

Here, the range A indicating surrounding images of a key image is a value indicating the number of medical images, or a value indicating a distance determined from a slicing position. If the range “A” indicates a distance, a maximum number of tomograms that does not exceed “A” with a tomogram corresponding to the position of a key image as a center are stored in the medical image storage unit 23. In addition, it is preferable that the range “A” is set according to imaging conditions when thin sliced tomograms are acquired, such as the type of a medical image diagnostic apparatus during inspection, an inspection part, and an imaging position.

In addition, FIG. 3 shows that an example of the medical image information is tomograms obtained by an X-ray CT apparatus or an MRI apparatus. However, as described above, the technique of the present embodiment can also be applied to an ultrasonic diagnostic apparatus or an X-ray diagnostic apparatus. In this case, since the medical image information is acquired as moving images not the tomograms, time information becomes array information. Accordingly, the range A indicating surrounding images of a key image becomes a value indicating the number of medical images, or a value indicating a time range.

Further, if the key image information corresponding to a deletion target inspection is not stored, tomograms are not used for generation of a diagnosis report. Thus, for example, all the thin sliced tomograms may be left or all the tomograms may be deleted. Further, a flag indicating whether or not a series of medical images has been interpreted may be set in medical image information so that, if any key image information is not stored, only an interpreted medical image may be deleted.

As described hitherto, according to the present embodiment, the resources of the image server 2 can be utilized effectively by leaving only the highly-required thin sliced tomograms among those stored in large quantities in the medical image storage unit 23, and deleting the other.

Further, since the medical image data deleted from the medical image storage unit 23 is stored in the medical image storage unit 26 that is a secondary storage unit, this data can also be restored if necessary.

Here, in the processing of Step S8 of FIG. 2, deletion target images are deleted from the medical image storage unit 23. However, the deletion target images may be stored in the medical image storage unit 23 in a state where the compression rate thereof is made higher than the compression rate of the other medical image data.

Further, the medical image storage unit 26 for storing the deletion target images shown in FIG. 1 is not necessarily required.

Moreover, in the present embodiment, a medical image storage apparatus is incorporated into a diagnosis report generating system. However, the diagnosis report generating apparatus 3, etc. may not be necessarily required if it is constructed so as to be able to input key image information to the key image information storage unit 25. Further, if key image information or imaging information is included in a series of medical image data, a key image can be specified from the medical image data. Thus, the key image information storage unit 25 also becomes unnecessary.

Further, although FIG. 3 shows that all interpretation images (thick sliced tomograms) are stored in the medical image storage unit 23, only a predetermined number of interpretation images in front of and behind a key image may be stored.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medical image storage apparatus comprising:
a first image storage unit that stores medical image information including a plurality of medical images having predetermined array information;
an image specifying unit that specifies a key image from the plurality of medical images on the basis of key image information showing a key image in the medical image information, and that specifies a predetermined number of medical images on the basis of the key image information and the array information; and
an image storage and management unit that deletes a medical image excluding the specified medical images of the medical image information from the first image storage unit or compresses the medical image at a higher compression rate than the key image.

2. The medical image storage apparatus according to claim 1,
wherein the image storage and management unit makes the medical image excluding the specified medical images of the medical image information stored in a second image storage unit provided outside the medical image storage apparatus.

3. The medical image storage apparatus according to claim 1,
wherein the image specifying unit determines the predetermined number on the basis of the imaging information when the medical image information is acquired.

4. The medical image storage apparatus according to claim 3,
wherein the imaging information includes at least any one of the type of a medical image diagnostic apparatus that has acquired the medical image information, and of inspection contents, an inspection part, and an imaging position when the medical image information is acquired.

5. The medical image storage apparatus according to claim 1,
wherein the medical image information comprises a first medical image information group including a plurality of medical images having first array information, and a second medical image information group including a plurality of medical images having second array information and relating to the first medical image group,
the key image is included in the second medical image group, and
the image specifying unit specifies the second medical image group on the basis of the key image information showing the key image.

6. The medical image storage apparatus according to claim 5,
wherein the first medical image group and the second medical image group are a series of DICOM.

7. The medical image storage apparatus according to claim 5,
wherein the image specifying unit further specifies a predetermined number of medical images from the first group, on the basis of the key image information and the first array information.

8. The medical image storage apparatus according to claim 1,
wherein the medical image information includes processed images obtained by performing predetermined processing on medical images included in the medical image information, and
the image specifying unit further specifies the processed images.

9. The medical image storage apparatus according to claim 1,
wherein, if the key image cannot be specified by the image specifying unit, the image storage and management unit deletes or compresses all the plurality of medical images, from the first image storage unit.
